(19) United States
(12) Patent Application Publication
(10) Pub. No.: US 2012/0059520 A1
(43) Pub. Date: Mar. 8, 2012

(54) SYSTEMS AND METHODS TO ROBOTIZE PAYLOAD EQUIPMENT

(76) Inventor: Alex J. Kossett, Minneapolis, MN (US)

(21) Appl. No.: 13/226,279

(22) Filed: Sep. 6, 2011

Related U.S. Application Data
(60) Provisional application No. 61/380,163, filed on Sep. 3, 2010.
(60) Provisional application No. 61/380,161, filed on Sep. 3, 2010.
(60) Provisional application No. 61/380,167, filed on Sep. 3, 2010.

(51) Int. Cl. B25J 13/02; B60K 1/02

(52) U.S. Cl. 700/264; 180/65.6; 180/65.1; 901/23; 901/25

(57) ABSTRACT

A robotic vehicle capable of collapsing into a small form factor for ease of transportation and providing for a quick transition to a deployed configuration. The vehicle can be configured to carry a payload when deployed. The vehicle can have an elongate body with two folding spoke-wheels at either end of the body that conform to the shape of the body when collapsed and extend perpendicular to the body when deployed. The vehicle can have an elongate body with two folding arms that each includes a drive motor and a gear assembly. The gear assembly is configured to receive removable wheels at either end of the body. The arms can be parallel to the length of the body when collapsed and extend perpendicular to the body when deployed. The vehicle can include a removable bracket configured to receive an explosive payload.

### RELATED PATIENT APPLICATIONS

The present application claims priority to U.S. Provisional Patent Application Nos. 61/380,161, 61/380,163, and 61/380,167, filed on Sep. 3, 2010, each of which is incorporated herein by reference.

### FIELD OF THE INVENTION

The present invention relates to robots. More particularly, the present invention relates to collapsible surveillance robots configured to carry a payload, as well as accessories and drive configurations for surveillance robots.

### BACKGROUND OF THE INVENTION

During combat and other situations when an adversary may be encountered, obtaining visual surveillance of the surrounding environment can be beneficial. Gaining an appropriate visual vantage point, however, often places individuals and equipment in harm's way. For example, peering through a doorway to look into an adjacent room can expose an individual to hostile fire. Personnel ascending and descending stairwells and entering attic spaces can be similarly exposed to hidden or unexpected dangers.

Outdoor environments can provide similar obstacles to visual surveillance which, when circumnavigated or avoided, may expose an individual to hostile fire. Such obstacles can include, for example, walls, fences, berms, buildings, rock formations, and the like.

Existing surveillance equipment for providing indirect visualization of a desired environment varies in complexity from extendable mirrors to mobile robots. The use of robotic surveillance systems is becoming increasingly common in hostile environments. The robots used in these surveillance systems are utilized to provide visual images. After delivery into an area to be surveilled, such as by throwing, the robots can be remotely maneuvered with an operator control unit to position the robot and embedded camera as desired by a user. A drawback of these devices is that their use is limited by the availability of terrain (i.e., a ground surface) or objects that can support the robot. A further drawback is that once positioned into a hostile environment, retrieval of the robot can be limited or impractical due to the presence of adversaries and physical obstacles that cannot be overcome after delivery, such as occurs when a robot is thrown over a wall.

Existing surveillance equipment is also highly customized for a specific task. The use of robotic surveillance systems can provide visual images or audio surveillance, however existing devices no not lend themselves to being customized to meet the varying needs that may be encountered in a hostile military or law enforcement environment.

Additional information regarding two-wheeled robots can be found in U.S. Patent Publication No. 2010/0152922, and U.S. Pat. No. 7,559,385, each of which is incorporated herein by reference.

### SUMMARY OF THE INVENTION

One embodiment of the present invention includes a robotic vehicle capable of collapsing into a small form factor for ease of transportation and providing for a quick transition to a deployed configuration. The vehicle can be configured to carry a payload when deployed.

Examples of payloads can include sensor packages, battery packages, weapons, or explosives, such as a shaped charge, including a water based shaped charge usable, for example to detonate or disable improvised explosive devices (IEDs) in ground based vehicles or the like.

One embodiment of the present invention includes interchangeable spoke elements that can hinge at a pin element on a wheel hub to fold against the body of the robotic vehicle for storage or transport. The body of the robotic vehicle can include various electronic controls, sensors, one or more batteries, and a motor and drive mechanism coupled to a pair of hubs. The spoke elements can also fold out, and secured in a deployed radial configuration, generally perpendicular to the body of the vehicle to form a wheel like assembly. The spoke elements are maintained in either their folded or deployed configuration by an end cap assembly that can be removably attached to a wheel hub with a fastening mechanism. Various spoke elements can be interchangeably connected to the body of the robotic vehicle depending on the desired wheel radius or the type of terrain where the vehicle is to be deployed.

One embodiment of the present invention includes arm assemblies that can house an electric motor attached to each side of a body of a robotic vehicle. The arm assemblies can rotate approximately 90 degrees between a deployed and a folded (or stowed) configuration. Coupled to the arm assembly is a gearbox that can detachably couple a wheel to the motor. A payload can be attached to the underside of the body of the robotic vehicle. Wheels of various diameter can be coupled to the gearbox thereby accommodating payloads of different dimensions when attached to the robot body. The robot body can also be coupled to a tail or counterweight to provide stability and maintain an upright orientation of the robotic vehicle.

One embodiment of the present invention includes a bracket assembly sized and configured to fit around the body of a robotic vehicle. The bracket assembly can be coupled to the robotic vehicle and provide a mounting point or tab assembly configured to mate with a payload. Examples of payloads can include sensor packages, battery packages, weapons, or explosives, such as a shaped charge, including a water-based shaped charge usable, for example to detonate or disable improvised explosive devices (IEDs) in ground based vehicles or the like.

### BRIEF DESCRIPTION OF THE DRAWINGS

The embodiments of the present invention may be more completely understood in consideration of the following detailed description of various embodiments of the invention in connection with the accompanying drawings, in which:

FIG. 1 is a perspective view of a collapsible robot device according to an embodiment of the present invention.

FIG. 2 is a perspective view of the robot device of FIG. 1 with collapsed spoke wheels.

FIG. 3 is a perspective view of a robot device and payload according to an embodiment of the present invention.

FIG. 4 is an exploded perspective view of a robot device and payload of FIG. 3.

FIG. 5 is a cross-section view of a gear assembly and the collapsed spoke wheels of FIG. 2.

FIG. 6 is a cross-section view of a robot device with an end cap disconnected from a hub.

FIG. 7 is a cross-section view of the extended spoke wheels of the robot device of FIG. 1.

FIG. 8 is a cross-section view of a hub of a robot device according to an embodiment of the present invention.

FIG. 9 is a perspective view of a robot device according to an embodiment of the present invention.

FIG. 10 is a perspective view of a robot device of FIG. 9 in a collapsed configuration.

FIG. 11 is a perspective view of a robot device according to another embodiment of the present invention.

FIG. 12 is an exploded perspective view of robot device components of FIG. 11.

FIG. 13 is an exploded perspective view of robot device components according to an embodiment of the present invention.

FIG. 14 is a cross-section view of a robot device drive assembly according to an embodiment of the present invention.

FIG. 15 is another cross-section view of a robot device drive assembly according to an embodiment of the present invention.

FIG. 16 is a rear perspective view of a robot device with a payload according to an embodiment of the present invention.

FIG. 17 is a front perspective view of a robot device of FIG. 16.

FIG. 18 is a bottom perspective view of a robot device of FIG. 16.

FIG. 19 is an exploded perspective view of robot device components of FIG. 16.

FIG. 20 is a perspective view of an exemplary control computer for operation of a robotic device according to an embodiment of the present invention.

FIG. 21 is an illustration of an exemplary military explosives container sized to contain a robot device according to an embodiment of the present invention.

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention,

### DETAILED DESCRIPTION OF THE DRAWINGS

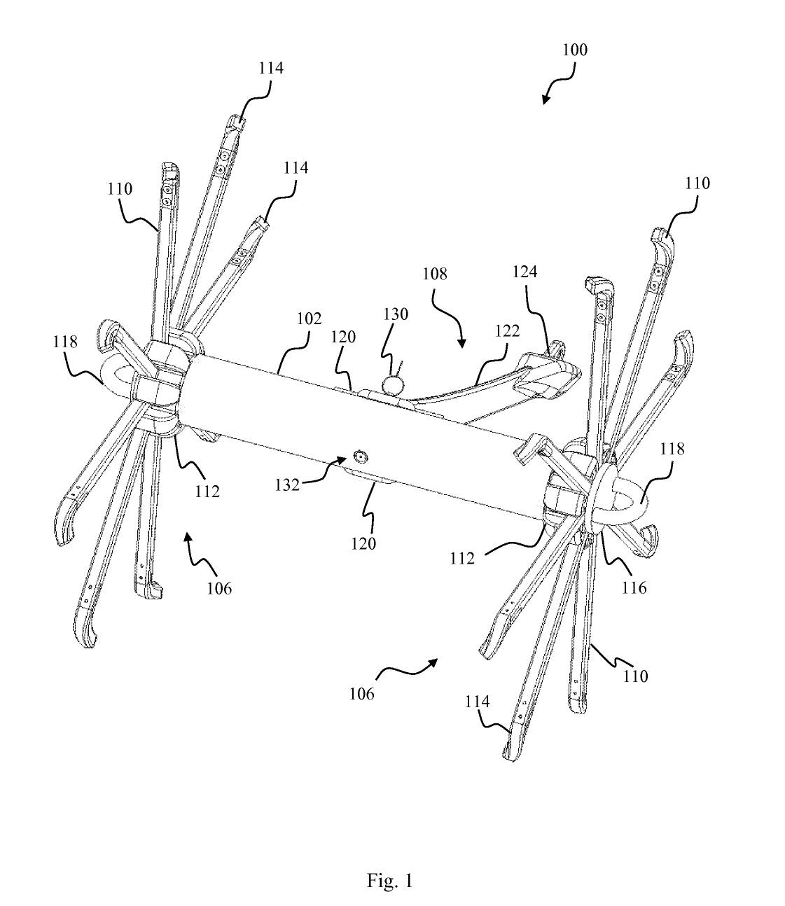

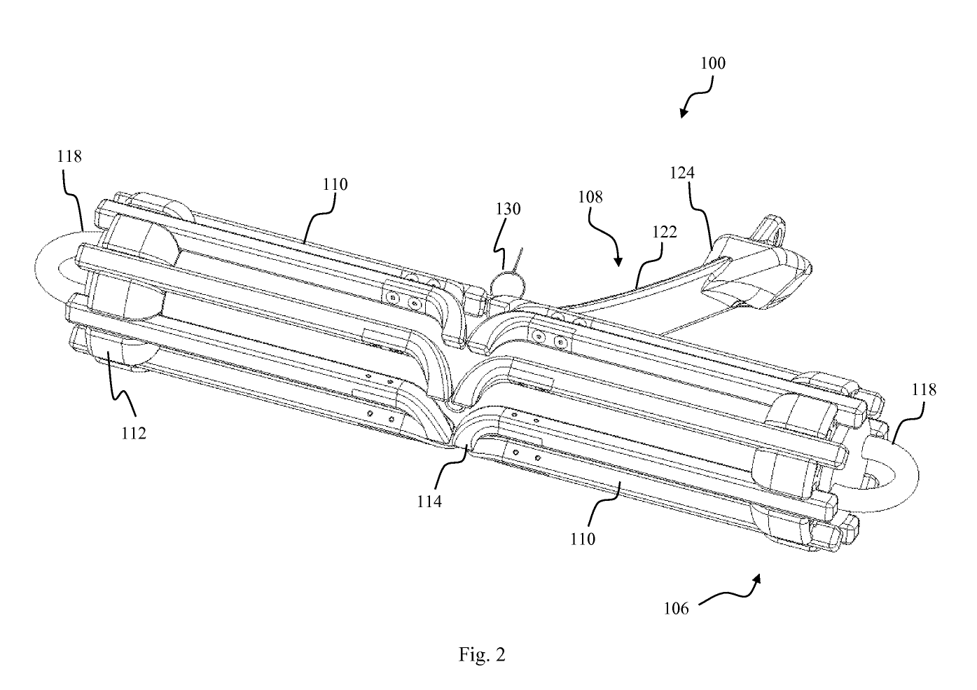

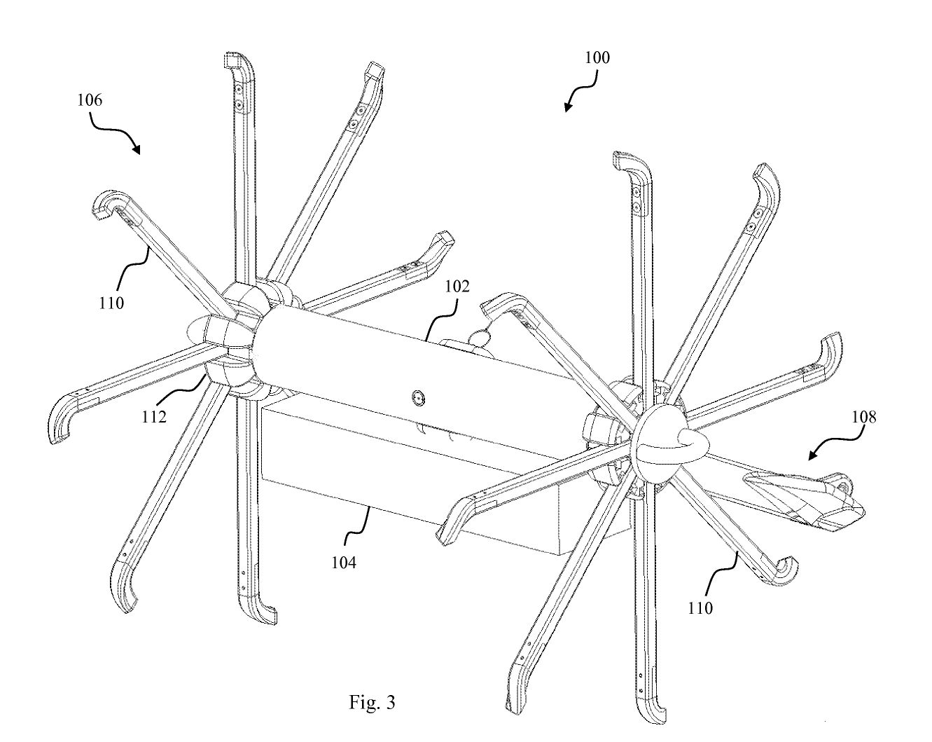

FIG. 1 depicts one exemplary embodiment of the present invention, which includes a miniature robotic vehicle 100 capable of collapsing into a small form factor for ease of transportation. FIG. 2 depicts the robotic vehicle 100 in a collapsed configuration. The vehicle 100 can carry a payload 104 when in the deployed configuration. As depicted in FIG. 3, the payload 104 can be placed below the body 102 of the robotic vehicle 100. Payload 104 can be secured to the robotic vehicle 100 with hook-and-loop straps, a bracket system and fasteners, or another appropriate fastening mechanism.

The robotic vehicle 100 includes two wheel assemblies 106 for locomotion and a tail assembly 108 for stabilization and orientation of the body 102. In one embodiment the wheel assemblies 106 and body 102 of the robotic vehicle 100 are sized such that the payload 104 is suspended approximately six-inches above the surface the robotic vehicle 100 is disposed upon. In one embodiment an exemplary payload has external dimensions of approximately 32 centimeters in length, 5 centimeters in width×8 centimeters in depth and a weight of approximately 1 kilogram.

The wheel assemblies 106 include foldable wheel spokes 110 that are hinged on a wheel hub 112. When the wheel spokes 110 are deployed the wheel assemblies 106 and wheel hub 112 rotate relative to an axis of the robot vehicle body 102, providing locomotive force to propel the robot vehicle 100. The use of alternate length spokes 110 can vary the height at which the payload 104 is suspended within a range of one to eighteen inches above the surface the robot device 100 is disposed upon.

The foldable wheel spokes 110 can include spoke ends 114 that can be shaped to conform to the exterior shape of the robot body 102, allowing for a compact packed form. The spoke ends 114 can include firm rubberized feet, solid metallic or plastic feed, or any of a variety of materials to provide traction on whatever surface the robot vehicle 100 is disposed. The spoked design of the wheels enables locomotion over difficult terrain and the scaling of obstacles in the path of the robotic vehicle 100.

An end cap 116 can secure the spokes 110 in either a folded (collapsed) or unfolded (deployed) position by supporting the spoke 110 at some distance from its pivot point. When in the folded position, as depicted in FIG. 2, the end cap 116 supports the short end of the spoke 110 radially, preventing the spoke 110 from rotating away from the robot's body 102. In the collapsed configuration the robot 100 requires a relatively small volume to ease transportation of the robot, while the large size in the deployed configuration gives the robot vehicle 100 more payload capacity and improves the robot 100 terrain navigation and locomotion capabilities. When in the unfolded position, as depicted in FIGS. 1 and 3, axial support bye end cap 116 prevents the spokes 110 from moving toward the robot's body 102. The end cap 116 can include a cap handle 118 to allow an operator to remove the end cap 116 in order to transition the spokes 110 between either the collapsed or deployed configurations.

Referring again to FIGS. 1 and 2, the tail assembly 108 can include a fastening mechanism 120, a tail extension 122 and a weight 124. The tail extension 122 can be rigid or flexible such that the weight 124 acts as a counterweight to the rotation of the robot vehicle body 102 when the wheel assemblies 106 rotate.

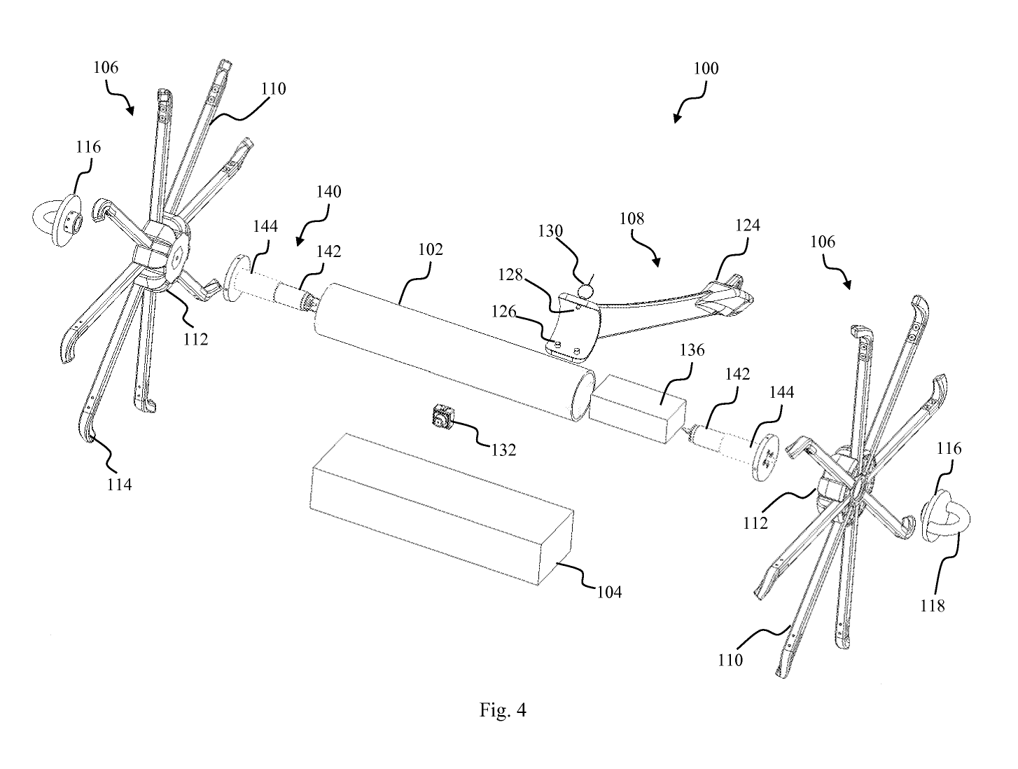

Referring to FIG. 4, the tail assembly 108 can attach to the robot body 102 with any of a variety of mechanisms. Preferably the fastening mechanism securely mounts the tail assembly 108 to the robot vehicle body 102 to prevent the tail assembly 108 from detaching during operation, while also allowing quick attachment/detachment of the tail by an operator. In one exemplary embodiment of the tail assembly 108 two pins 126 fixed to the tail and one retractable spring-loaded pin 128 fixed to the tail fastening mechanism 120. The retractable spring-loaded pin 128 can be actuated by a handle or key ring 130 coupled to the pin 128 and disposed on an outer surface of the tail assembly 108. The tail assembly 108 can be installed on the robot vehicle body 102 by placing the fixed pins in complementary holes on the robot vehicle body 102 and pushing the tail 108 against the body 102 of the robot 100. The rounded shape of the body 102 allows the retractable pin 128 to be recessed as the tail 108 is pushed toward the body 102, until the pin 128 reaches a complementary hole and extends into it, locking the tail 108 in place. The tail 108 can be removed by retracting the pin 128 with, for example, a key ring 130, and then moving the tail 108 away from the body 102.

The robot vehicle 100 can also include a variety of electronic components for the reception and transmission of control and sensor data, a battery and supporting electronics to supply power at varying voltages and ensure safe operation, and one or more sensors such as a camera 132. An exemplary electronics package 136 and motor drive train assembly 140 are depicted in FIG. 4. The robot vehicle 100 includes motors 142, which drive the wheels 106 either directly or through a gear assembly 144 having, for example, meshing gears, or pulleys and belts to connect the motor 142 to the wheels 106. The electronics package 136, drive train assembly 140, and camera 132 can all be housed within the robotic vehicle body 102.

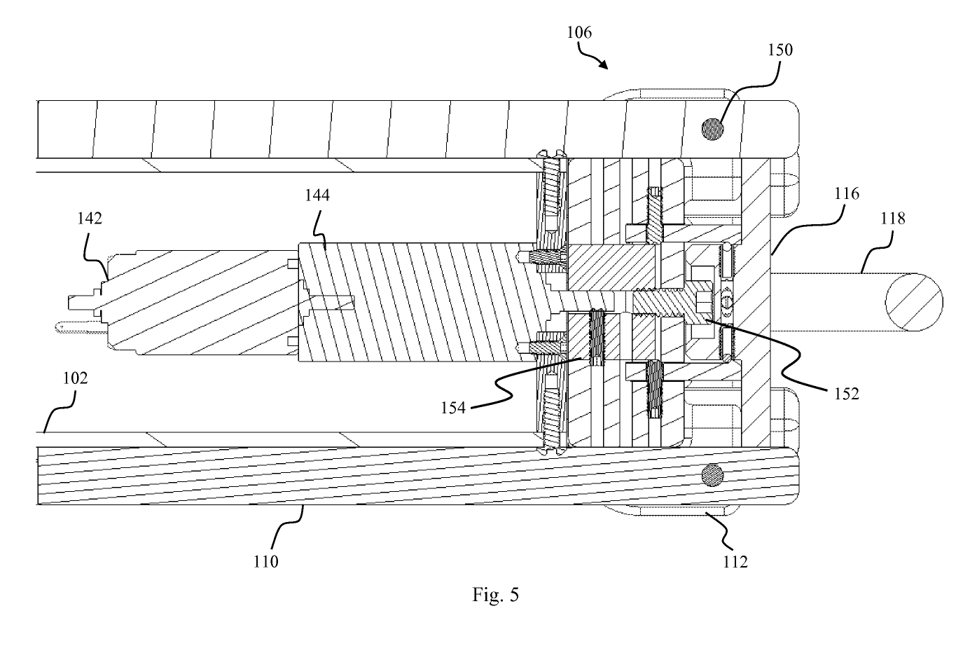

The robot can be easily converted from its packed configuration to its deployed configuration or vice versa by an operator with minimal training. Referring to FIG. 5, the robot 100 is a folded configuration, with all spoke members 110 oriented parallel to a long axis of body 102. The hub 112 can include a pivot 150 that couples each spoke 110 to the hub 112 such that the spoke 110 can rotate about the pivot 150 in a channel formed in the hub 112. The hub 112 can include a fastener 152 that couples the hub 112 to a threaded collar 154 that is secured to a shaft of the gear assembly 144.

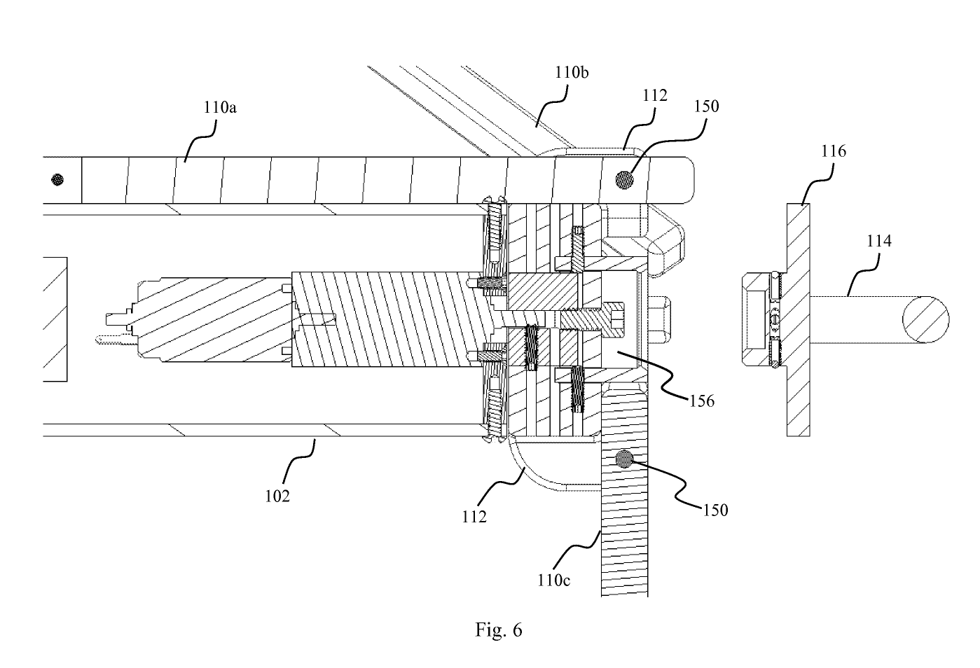

Referring to FIG. 6, the end cap 116 is removed from the hub 112, thereby allowing the spokes 110 to freely rotate about their respective pivots 150. Hub 112 can include a recessed cavity to accommodate a portion of end cab 116 and provide a friction or other locking fit to secure the end cap 116 to the hub 112. As depicted in FIG. 6, a first spoke member 110a is in the folded configuration, spoke member 110b is at an acute angle relative to the body 102 between the extended and the folded configuration, and spoke member 110c is disposed in the fully extended configuration.

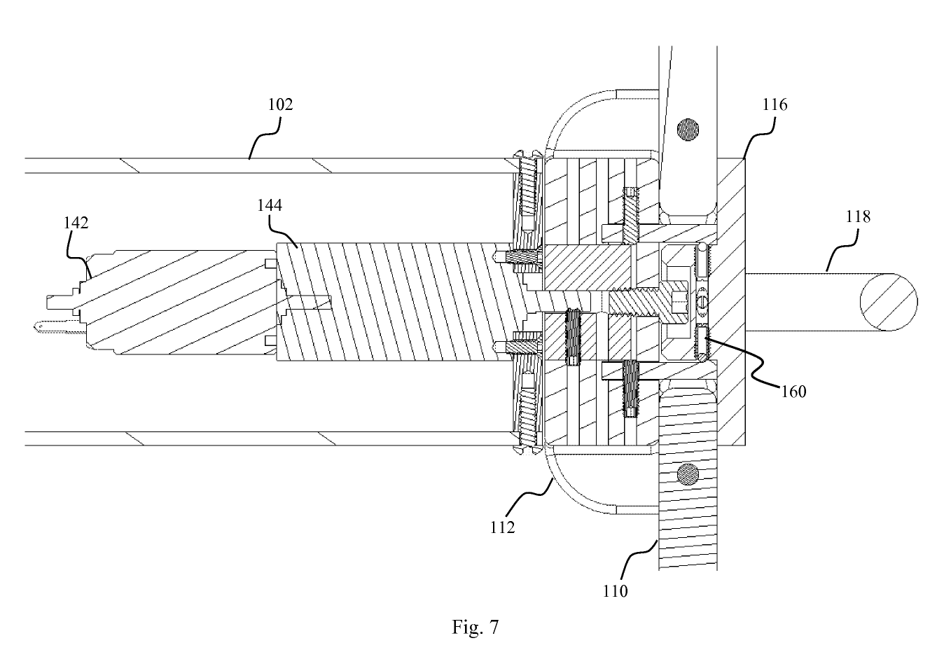

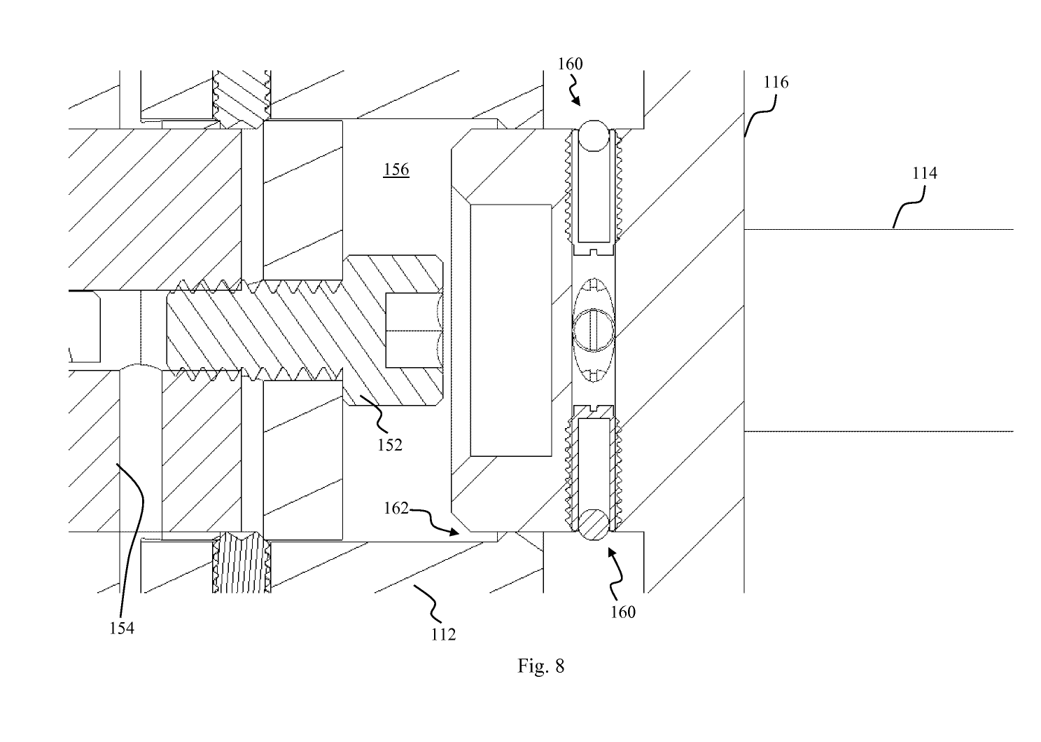

Referring to FIG. 7, the end cap 116 is mated to the hub 112 with all of spokes 110 in the deployed configuration. Referring to FIG. 8, the end cap 116 can include spring-loaded ball plungers 160 that engage angled features 162 in a snap insert on the wheel hub 112 to lock end cap 116 in place on the wheel hub 112. With sufficient force from an operator, the end cap 116 can be removed by pulling axially on the end cap handle 118. Other mechanisms to secure the end cap 116 can be used, such as a threaded connection or a “bayonet lock” connection, wherein pins on the wheel hub engage with track features on the end cap and prevent axial motion.

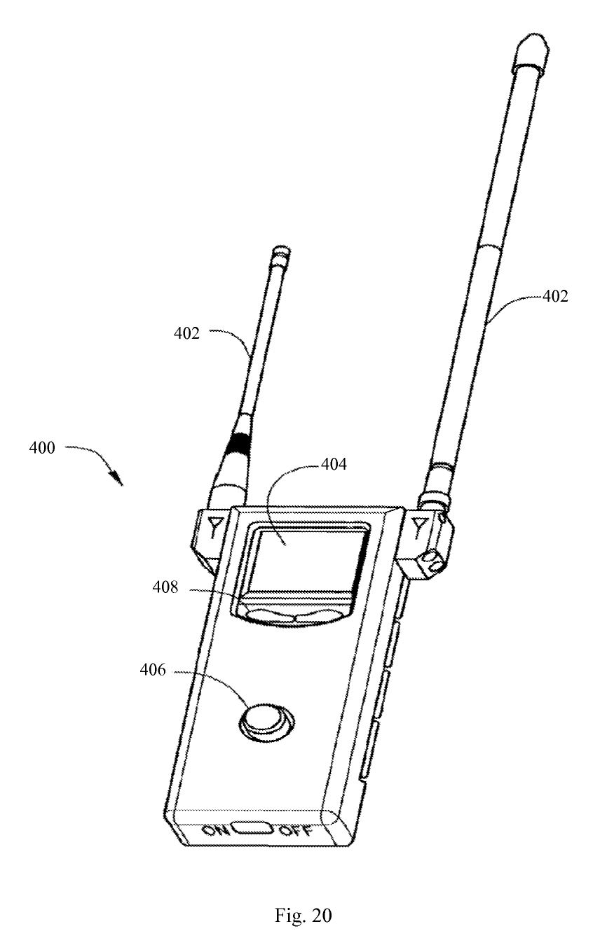

The robot 100 can be controlled and monitored remotely with a complementary handheld unit operated by a user with minimal training. An exemplary unit is depicted in FIG. 20 and discussed in more detail below. The handheld unit can include transmitters and receivers complementary to the robot's transmitters and receivers, an interface such as a video screen to monitor the robot's environment, and a control interface such as a joystick or set of buttons. The handheld until can also include specialized transmitters configured for used with an explosive payload that can be attached to the robot. In one embodiment the payload 104 can be an explosives package can be configured to destroy both a targeted improvised explosive device (IED) and the robot simultaneously. The robot 100 can carry a payload 104 to deliver it to a location or an alternative payload can be configured to expand the capabilities of the robot 100, for example with additional sensors or battery capacity.

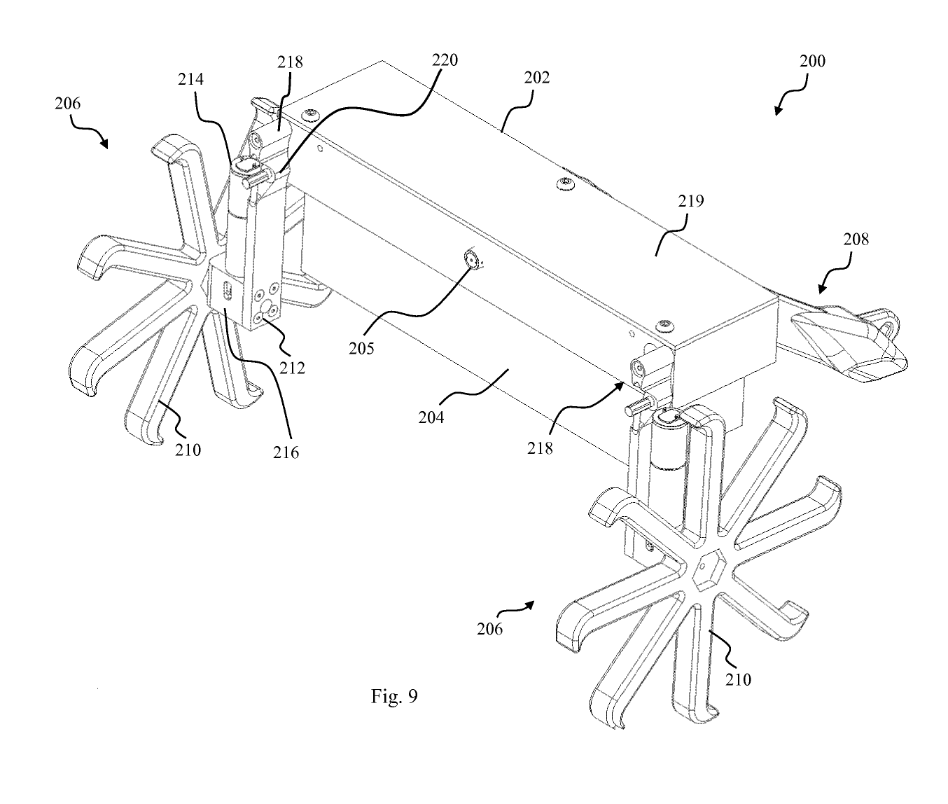

A robot device 200 according to an embodiment of the present invention is depicted generally in a deployed form in FIG. 9. The robotic device 200 includes a body 202 sized to carry a payload 204 attached to the body 202. The body 202 is coupled to two wheel assemblies 206 for locomotion, and a tail assembly 208 for stabilization and orientation of the body 202. The body also encloses a set of electronics for controlling the robot device 200 as well as transmitting any data received by sensors, for example a camera 205, mounted on or attached to the body 202.

The robot device 200 can carry a payload 204 when deployed, which can be placed below the body 202 or electronics enclosure of the device 200 and secured via hook-and-loop straps or another fastening mechanism such as a detachable bracket or other fasteners. In one embodiment the wheel assemblies 206 and body 202 of the robotic device 200 are sized such that the payload 204 is suspended approximately six-inches above the surface the robotic device 200 is disposed upon. The use of alternate diameter wheels 210 or wheel assemblies 206 can provide a height at which the payload 204 is suspended in a range of one to eighteen inches above the surface the robot device 200 is disposed upon.

The robot device 200 can be utilized for robotizing a payload 204, enabling the payload 204 to be delivered to a destination remotely by the communication of commands to the robot device 200 by an operator or autonomously by programming the robot device 200 to follow a sequence of preprogrammed commands.

Two wheels 210 and a driving means, such as electric motors 214, a tail 208, and supporting electronics in the body 202 are attached to a payload 204. The drivetrain can be integrated on arms 212 which are hinged on the exterior of the body 202. When packed, the arms 212 are positioned to lie in plane with the flat surface of the body 202, while the tail 208 and wheels 210 can be stored unassembled.

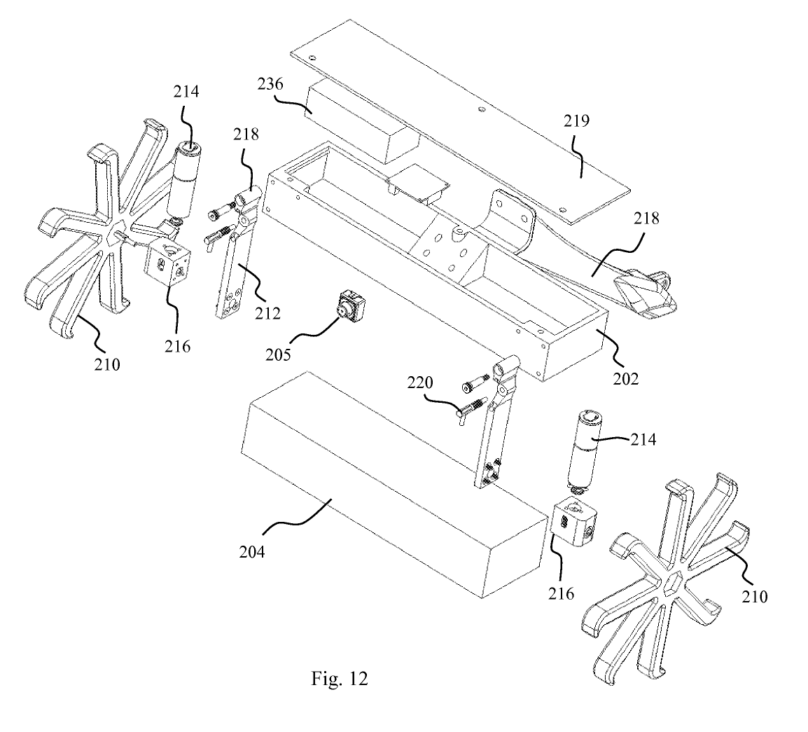

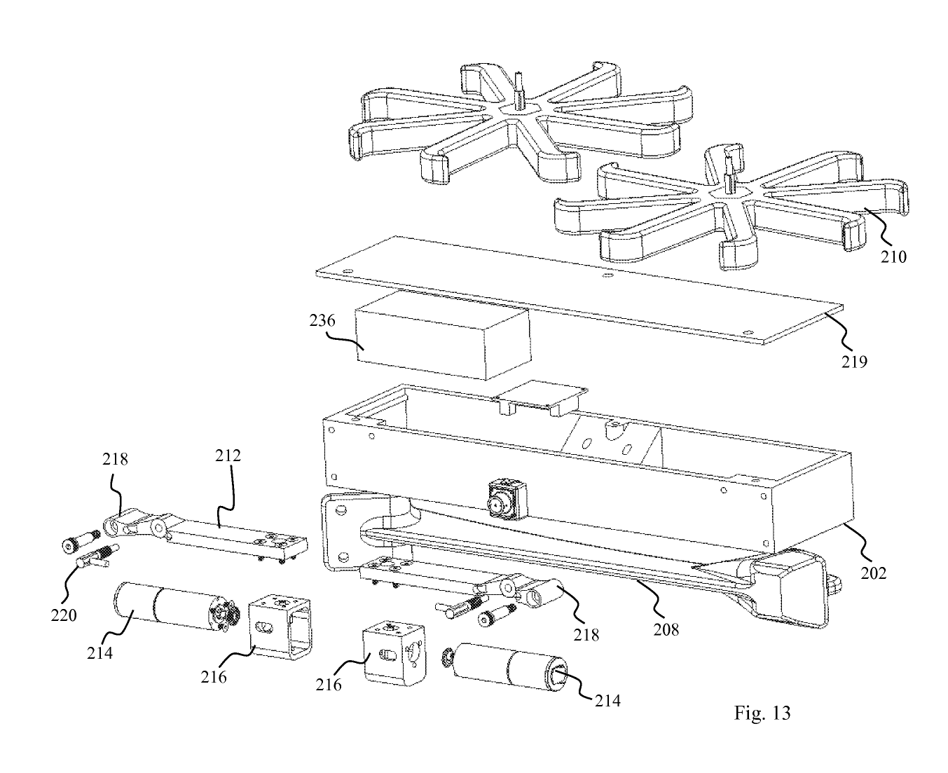

The wheel assemblies 206 include a removable wheel 210 mounted to an arm 212. Arm 212 can include a motor 214 and drive assembly or gear mechanism 216 coupled to the wheel 210 to propel the robot device 200. The arm 212 can rotate on a pivot 218 that connects the arm 212 to the body 202 of the robot device 200. Arm 212 can include a retractable spring plunger 220 that can secure the arm 212 in either the deployed and stowed position while allowing easy transition from stowed to deployed and the reverse. When deployed, the arms are rotated approximately 90 degrees and engage with a snap or locking feature (shown in FIGS. 12 and 13 as a retractable spring plunger 220) which locks the arm 212 in either a deployed or stowed position. The wheels 210 are inserted into the gearbox and the tail 208 is attached to the body 202.

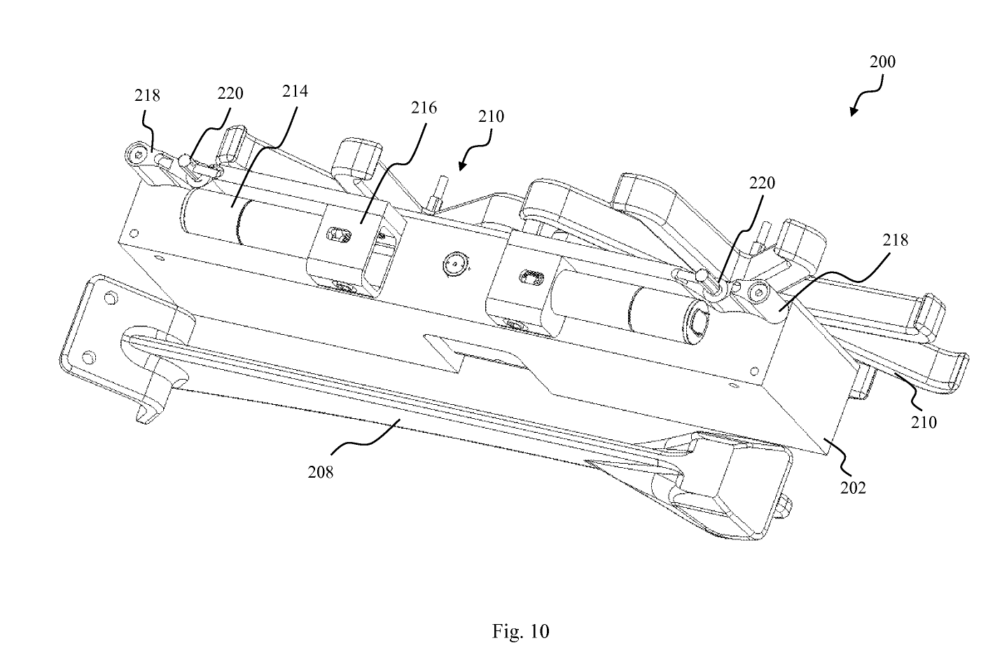

FIG. 10 depicts a robot device 200 in a folded or transport configuration. The robot device 200 can be collapsed into a small form-factor for ease of transportation. In the transport configuration the wheels 210 are detached from the wheel assemblies 206 and the tail 208 is detached from the body 202 of the robot device 200.

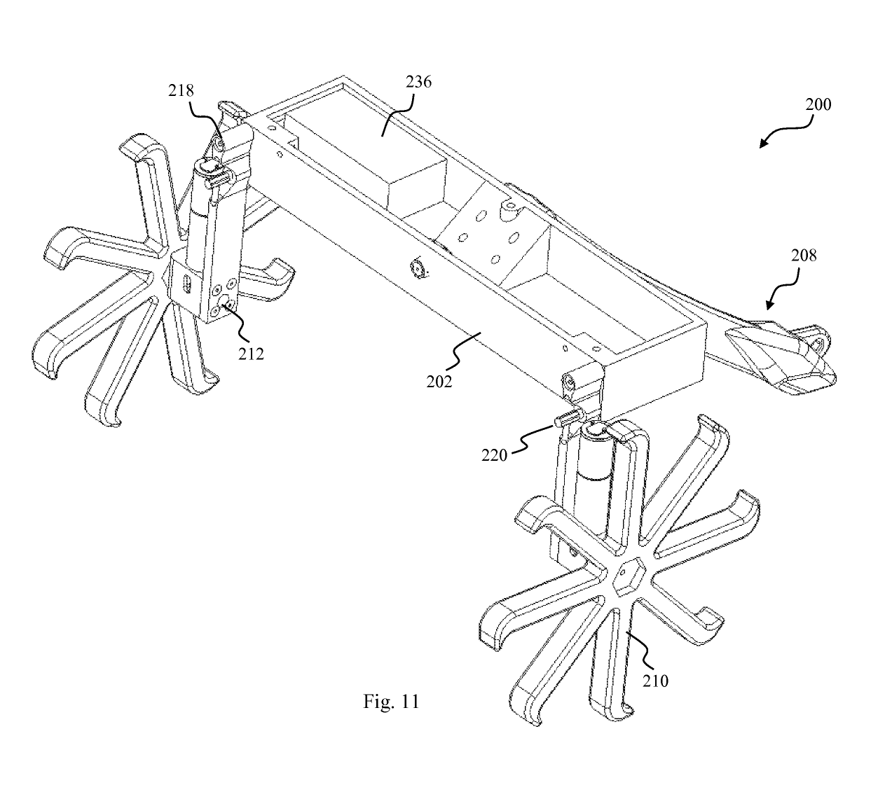

Referring to FIG. 11, a robot device 200 is depicted with the top cover 219 removed. The body 202 forms an enclosure that contains all electronics necessary for remote and/or autonomous operation, including but not limited to a battery, processor, processor memory, transmitter, receiver, and one or more sensors such as a video camera 205. An electronics package 236 can be disposed on one side of the enclosure formed by the body 202 with the opposite side providing space for additional battery capacity.

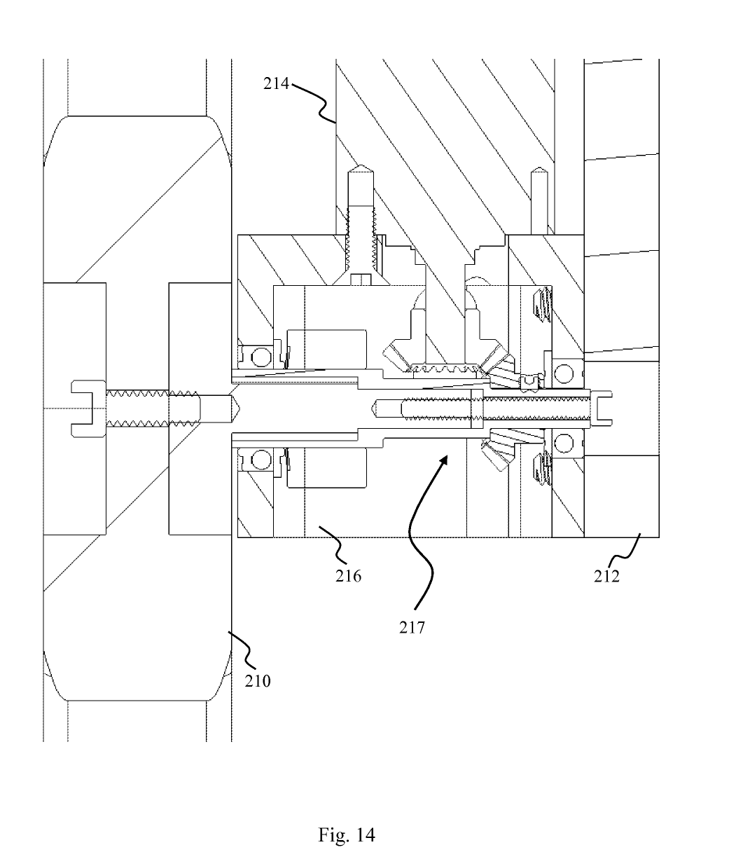

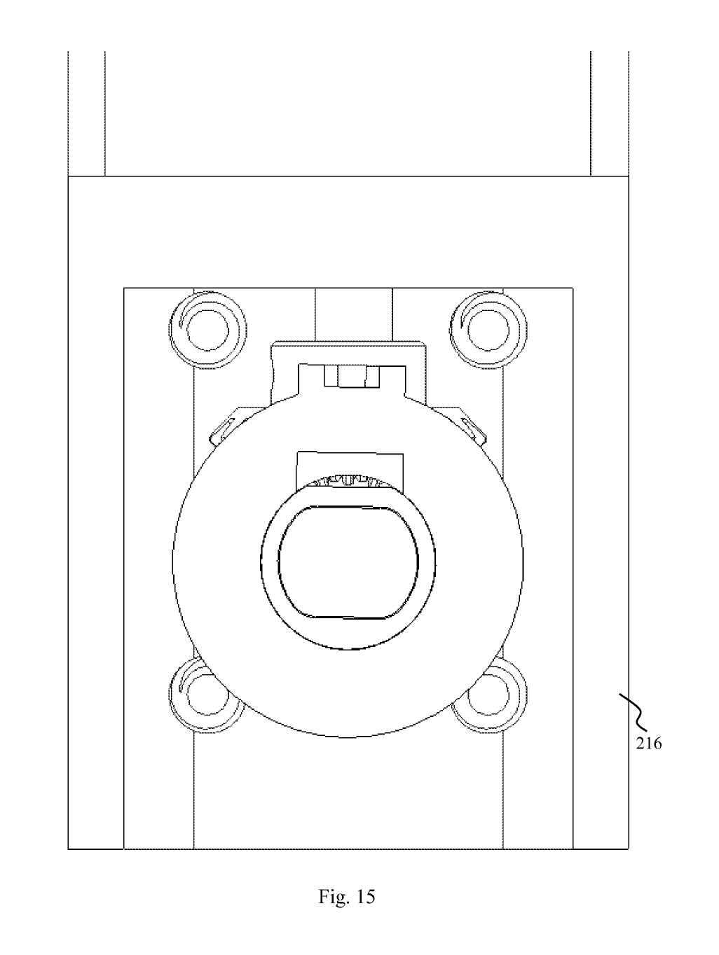

Referring to FIGS. 14 and 15, an exemplary embodiment of the gear mechanism 216 is mounted to arm 212 and couples the hub of wheel assemblies 210 to the electric motor 214 with a system of perpendicular meshing gears 217.

The robot can be controlled and monitored remotely with a complementary handheld unit 400 operated by a user with minimal training. The handheld unit 400 can include antenna 402, transmitters and receivers complementary to the robot's transmitters and receivers, an interface such as a video screen 404 to monitor the robot, and a control interface such as a joystick 406 or set of buttons 408. The handheld until 400 can also include specialized transmitters configured for used with an explosives payload that can be attached to the robot. In one embodiment the explosives package can be configured to destroy both a target IED and the robot 200 simultaneously.

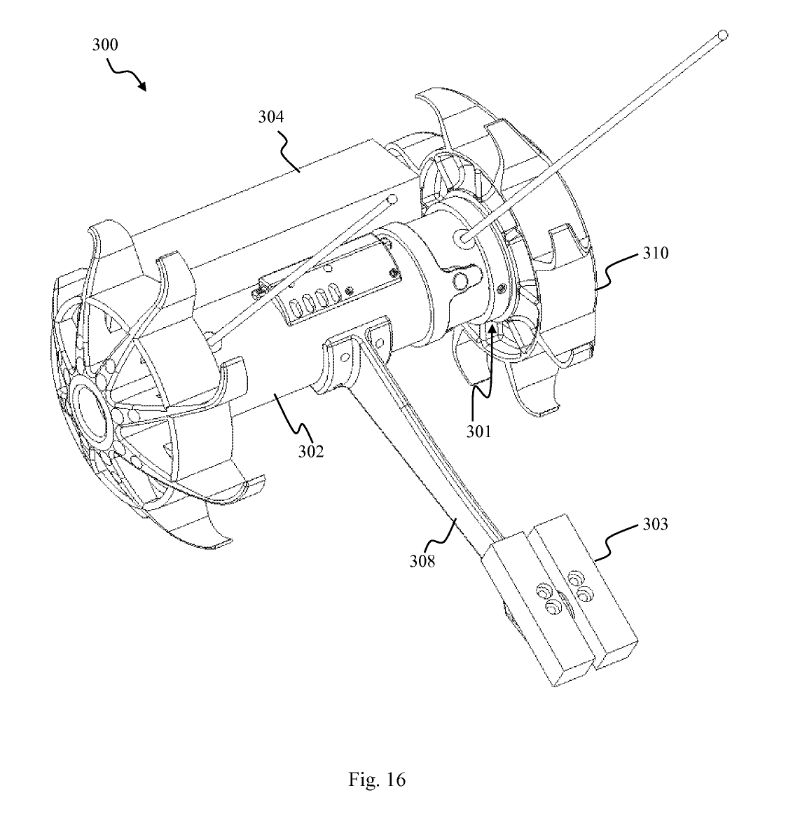

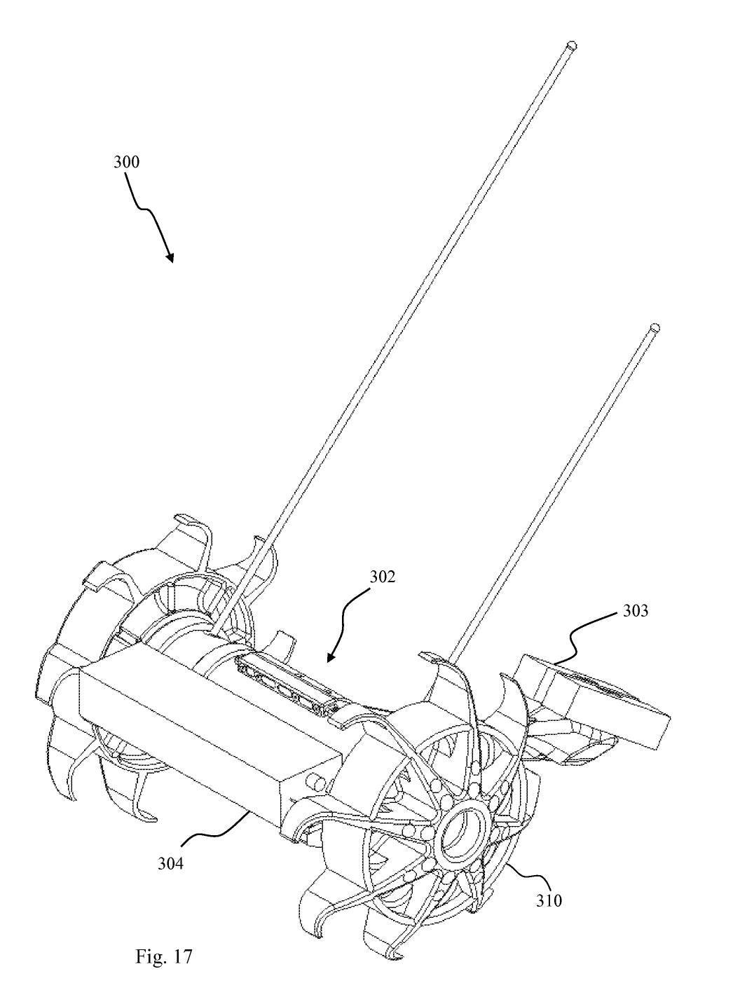

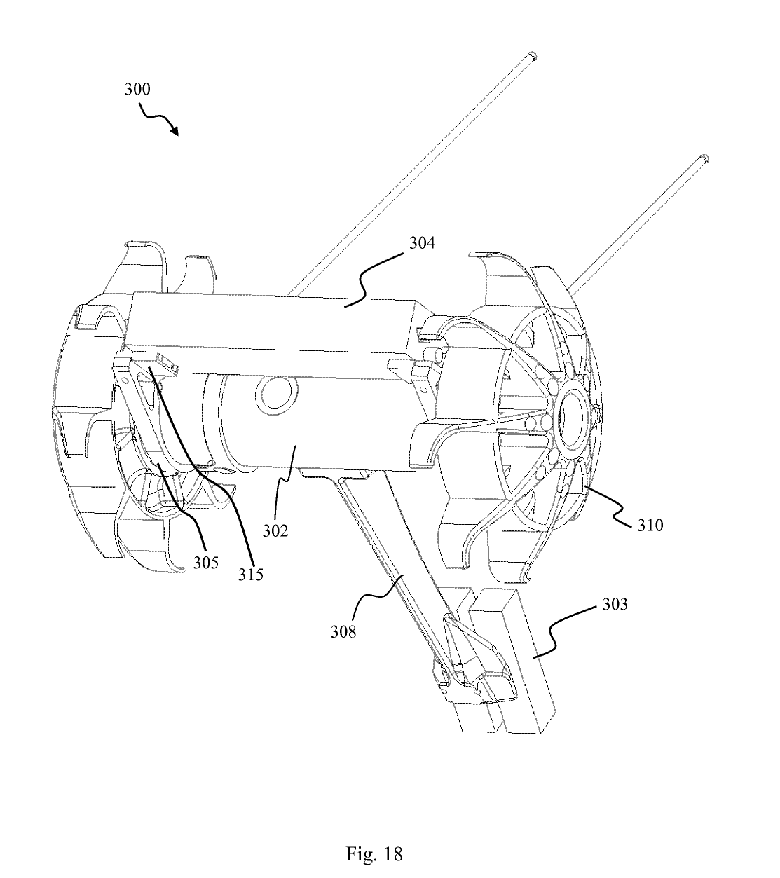

Referring to FIGS. 16-19, one embodiment of the invention includes a miniature robotic vehicle 300 equipped with a detachable mounting bracket 301 for transportation of a payload 304. The payload 304 can be secured via a slot and tab fastening mechanism as depicted or another fastening mechanism such as bolt-and-nut, screws, rivets or other mechanical connection means. A modular mounting bracket 301 enables the addition of a payload that can include sensors or other equipment to a robot to expand its capabilities, or an explosive charge that can be positioned precisely next to, below, or above a target in a dangerous environment with reduced risk to an operator.

The robotic vehicle 300 includes a body 302 uses two wheels 310 for locomotion and a tail 308 for stabilization of the body's orientation. In one embodiment the wheel assemblies 310 and body of the vehicle 300 are sized such that the payload 304 is suspended approximately six-inches above the surface the vehicle is disposed upon. The wheel assemblies 310 can be detached from the body 302 to allow the installation of bracket 301. An attachment-mounting bracket 301 for a miniature robot 300 enables the robot 300 to carry payload 304. The bracket 301 enables a robot to be equipped with a payload 304 without requiring access to the internal components of the robot 300. The internal components can include one or more motors, batteries, sensors and the like.

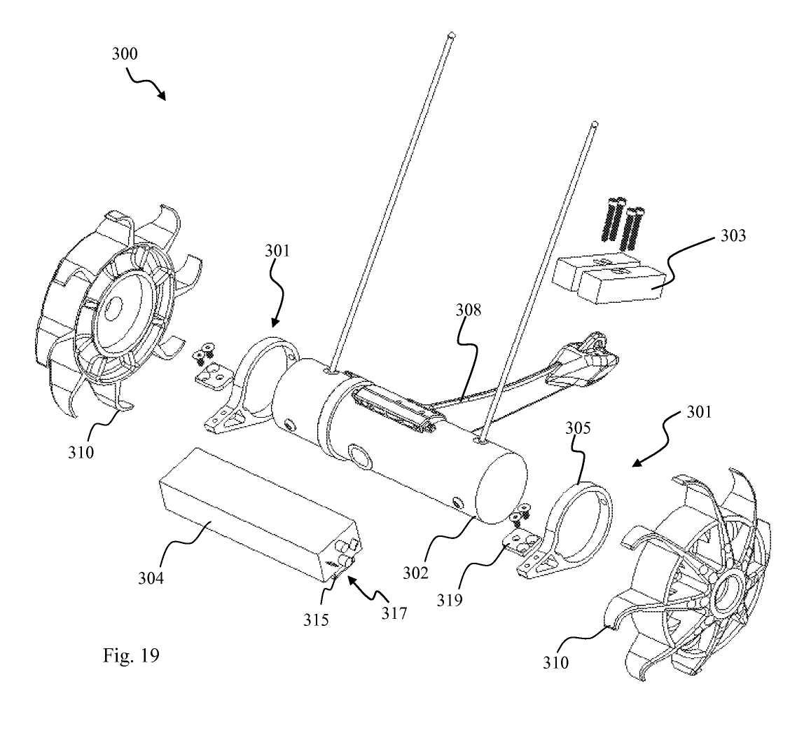

The bracket 301 has attachment points for the robot body 302 and the payload 304. The counterweight 303 has attachment points to connect to a portion of the robot 300 on the opposite side of the robot 300 from the payload 304. For example, if the payload 304 is on the front of the robot 300, the counterweight 303 can be placed on the back, for example on the end of a tail 308. The counterweight 303 serves to balance the weight of the payload 304 improving the dynamic performance of the robot 300 and enabling the use of the counterweight 303 while maintaining the correct orientation. As depicted in FIG. 19, the counterweight 303 can attached with screws to the tail 308 and can include two separate components. It can attach using a different interface or be a single element.

The ring 305 of bracket 301 can be replaced by a snap-on clip to eliminate the need to remove the wheels to assemble the attachment. The ring can be secured to the body 302 of the robot vehicle 300 with a screw or other fastening mechanism. The payload 304 can be attached to the bracket with screws or another appropriate fastening mechanism. Payload 304 can include a bracket 315 forming a slot 317 that is sized to receive tab 319. Tab 219 can be coupled to bracket 301 with fasteners or be included as an integrated component of an alternate embodiment of the bracket.

FIG. 20 illustrates an exemplary remote computer 400 that can be used to wirelessly transmit instructions to, and receive data from, the robotic vehicle 100, 200 or 300. The computer 400 can include antennae 402 to wireless communicate with the vehicle, and a display screen 404 to display information, e.g., camera views, pertaining to vehicle operation. Controls, such as a joystick 406 and buttons 408, can also be provided to remotely control the vehicle.

In one embodiment, the vehicle can receive commands from the remote computer 400 via an onboard 4-channel R/C receiver, utilizing two channels for motor control and two for other functions. In one embodiment the joystick 406 can include a switch that is activated when the joystick 406 is depressed. While the joystick 406 is depressed an operator can adjust the brightness of the display screen 404. The ability to adjust the brightness of display screen 404 can allow the operator to improve visibility of the display screen 404 in bright daylight conditions by depressing the joystick 406 and moving the joystick 406 upwards, towards the display screen 404. Conversely, in low light conditions, or when the operator does not wish to draw attention to himself, the operator can depress the joystick 406 and move the joystick 406 downwards, away from the display screen 404. A programmable controller in the computer 400 can include a software program stored in tangible computer-readable memory to interpret these brightness commands and adjust the intensity of the display screen (or appropriate backlight) in response to the manipulation of joystick 406.

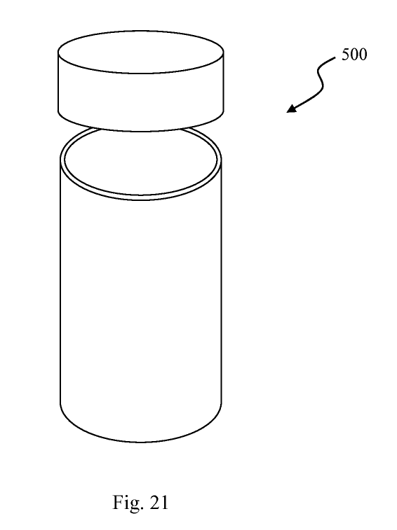

FIG. 21 depicts and exemplary military explosives container 500 with dimensions of approximately fourteen inches in height and five inches in diameter. Each of the robotic vehicles and devices described herein can be sized to fit into container 500, or a smaller container of approximately two-hundred-fifty to three-hundred-fifty cubic inches. Embodiments of each of the robotic vehicles and devices described herein can be sized to fit into container of no more than fifty cubic inches with a height of no more than ten inches and a diameter of no more than six inches.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A robotic vehicle comprising:
a body defining an interior compartment and an exterior surface, the body including two ends;
a pair of motors disposed within the interior compartment;
an electronics package disposed within the interior compartment electronically coupled to each one of the pair of motors, the electronics package being coupled to a video camera and at least one transmitter configured to transmit images from the video camera;
a collapsible wheel assembly coupled to each end of the body, the wheel assembly including a hub, a plurality of spokes coupled to the hub at a pivot, and a removable end cap physically mated to the hub, the hub being operably coupled to one of the pair of motors; and
a payload removably coupled to the exterior surface of the body;
wherein the removable end cap maintains the plurality of spokes in a first deployed configuration when mated to the hub.

2. The robotic vehicle of claim 1, wherein the payload is coupled to the exterior surface of the body by a bracket that surrounds a portion of the body and suspends the payload below the body.

3. The robotic vehicle of claim 1, wherein the payload is coupled to the exterior surface of the body by a bracket that surrounds a portion of the body and suspends the payload in front of the body.

4. The robotic vehicle of claim 1, wherein the plurality of spokes each include a curved foot at an end opposite an end where each spoke is coupled to the hub.

5. The robotic vehicle of claim 1, wherein the removable end cap includes a locking mechanism that secures the end cap to the hub; and
wherein the removal of the end cap allows the plurality of spokes to transition from a stowed configuration to a deployed configuration by rotation about the pivot, the end cap retaining the plurality of spokes in the stowed configuration or the deployed configuration when physically mated to the hub.

6. A robot device comprising:
a body defining an interior compartment and an exterior surface;
a pair of arms coupled to the exterior surface the body by a pivot, each one of the pair of arms including a spring-loaded locking pin configured to mate with a first port in the body when the arms are in a deployed position, and a second port in the body when the arms are in a stowed position, wherein each of the pair of arms can rotate between zero and ninety degrees between the deployed position and the stowed position;
a motor disposed on each one of the pair of arms;
a gear assembly coupled to the motor on each one of the pair of arms;
a removable wheel assembly operably coupled to each gear assembly;
a detachable tail assembly; and
a payload coupled to the body.

7. The robot device of claim 6, wherein each one of the pair of arms can rotate on the pivot independently of the other arm.

8. The robot device of claim 6, wherein the payload is coupled to the body with a removable bracket.

9. The robot device of claim 6, wherein the payload is coupled to an exterior surface on the underside of the body.

10. The robot device of claim 6, wherein the robot device can be completely contained in a container having a volume of between 45 and 55 cubic inches when in the stowed position.

11. The robotic device of claim 6, further comprising a tail coupled to the body and configured to act as a counterweight to offset the angular rotation of the pair of wheels.

12. A robotic vehicle comprising:
a body defining an interior compartment and an exterior surface, the body including two ends;
a pair of motors disposed within the interior compartment;
an electronics package disposed within the interior compartment electronically coupled to each one of the pair of motors;
a pair of wheels, each wheel being removably coupled to one of the pair of motors at each end of the body;
a pair of mounting brackets configured to surround a portion of the body at each end, and including an attachment point;
a payload coupled to the attachment point of the bracket.

13. The robot vehicle of claim 12, wherein the robot vehicle can be completely contained in a container having a volume between 250 and 350 cubic inches.

14. The robot vehicle of claim 12, wherein the robot vehicle can be completely contained in a container having a volume between 45 and 55 cubic inches.

15. The robotic vehicle of claim 12, wherein the payload is coupled to the exterior surface of the body by the mounting brackets such the payload is below the body.

16. The robotic vehicle of claim 12, wherein the payload is coupled to the exterior surface of the body by the mounting brackets such the payload is in front of the body.

17. The robotic vehicle of claim 12, further comprising a tail coupled to the body and configured to act as a counterweight to offset the angular rotation of the pair of wheels.

18. The robotic vehicle of claim 17, wherein the tail coupled to the body comprises a pair of removable counterweights that have a mass proportional to the mass of the payload.

19. A controller for a robotic vehicle comprising:
a joystick having a 360-degree range of horizontal motion and including a switch that is activated when the joystick is depressed vertically;
a pair of transmitters and receivers configured to communicate with the robotic vehicle;
a video display screen having a backlight that can be adjusted to vary a brightness level of the video display screen, the video display screen being configured to receive a video signal input from at least one of the pair of receivers; and
a processor coupled to the backlight, the joystick, and the pair of transmitters and receivers, the processor being configured to interpret operator actuation of the joystick and direct the robotic vehicle in response to the actuation of the joystick by transmitting commands via the pair of transmitters;
wherein the processor is further configured to adjust the brightness level of the video display screen by varying the intensity of the backlight in response to the combined actuation of the joystick and the switch.

20. The controller of claim 19, where in the video display screen is a liquid crystal display (LCD) screen.
